(19) United States
(12) Patent Application Publication
(10) Pub. No.: US 2020/0324716 A1
(43) Pub. Date: Oct. 15, 2020

(54) VEHICLE INTERIOR TRIM PANEL

(71) Applicant: GM Global Technology Operations LLC, Detroit, MI (US)

(72) Inventor: Chong Wang, Novi, MI (US)

(21) Appl. No.: 16/381,821

(22) Filed: Apr. 11, 2019

(51) Int. Cl. B60R 13/08; B60J 5/10; B60R 13/02

(52) U.S. Cl. CPC B60R 13/0815; B60R 13/0243; B60J 5/10

(57) ABSTRACT

A door assembly for a vehicle includes a door, an interior trim panel, and a resonant cavity. The door includes a first interior surface, a second interior surface, and a plurality of side surfaces. The door is fixed to the vehicle via a hinge assembly. The interior trim panel includes a third interior surface, a first exterior surface, and a plurality of arcuate surfaces. The interior trim panel is fixed to the first interior surface of the door and the first exterior surface and the third interior surface are connected by the plurality of arcuate surface. The resonant cavity is disposed between the door and the interior trim panel. The resonant cavity includes the second interior surface and the plurality of side surfaces of the door and the first exterior surface of the interior trim panel.

### INTRODUCTION

The present disclosure relates generally to interior trim panels for a vehicle and more particularly to interior trim panels having sound absorbing features.

Competition between vehicle manufactures has provided refinements in vehicle performance in the area of interior noise. While there are many improvements that result in higher cost and increased investment, improvements resulting in low or zero cost are not common. Also, improvement in some areas of noise, vibration, and harshness (NVH) can cause degradation in other areas of NVH. For example, improved sealing of the interior of the vehicle may decrease the amount of road noise that enters the vehicle cabin, however, some frequencies of noise may be amplified by the sealed cabin. In this regard, low frequency booming noise may actually be generated by the excitation of acoustic resonances of the interior cabin. The low frequency booming noise (typically from 100 Hz to 200 Hz) is thus attributed to the resonances of interior acoustic cavity modes.

Accordingly, there is a need in the art for improved interior trim panels for vehicles providing improved NVH performance of the vehicle cabin while maintaining or reducing costs.

### SUMMARY

A door assembly for a vehicle is provided. The door assembly includes a door, an interior trim panel, and a resonant cavity. The door includes a first interior surface, a second interior surface, and a plurality of side surfaces. The door is fixed to the vehicle via a hinge assembly. The interior trim panel includes a third interior surface, a first exterior surface, and a plurality of arcuate surfaces. The interior trim panel is fixed to the first interior surface of the door and the first exterior surface and the third interior surface are connected by the plurality of arcuate surface. The resonant cavity is disposed between the door and the interior trim panel. The resonant cavity includes the second interior surface and the plurality of side surfaces of the door and the first exterior surface of the interior trim panel.

In one example of the present disclosure, the interior trim panel further includes a plurality of holes each including one each of the plurality of arcuate surfaces.

In another example of the present disclosure, the resonant cavity of the door assembly communicates with a cabin of the vehicle through the plurality of holes of the interior trim panel.

In yet another example of the present disclosure, the resonant cavity has a volume between 0.015 m³ to 0.040 m³.

In yet another example of the present disclosure, the plurality of holes have a diameter between 0.75 mm and 1.25 mm.

In yet another example of the present disclosure, the door assembly includes a ratio of a total area of the plurality of holes and a total area of the third interior surface of the interior trim panel equal to between 0.13% and 0.19%.

In yet another example of the present disclosure, the plurality of holes of the interior trim panel includes between 600 and 1200 holes.

In yet another example of the present disclosure, the door is a vertically opening tailgate.

In yet another example of the present disclosure, the door assembly further includes a sound absorber disposed in the resonance cavity.

Another door assembly for a vehicle is provided. The door assembly includes a door, an interior trim panel, and a resonant cavity. The door includes a first interior surface, a second interior surface, and a plurality of side surfaces. The door is fixed to the vehicle via a hinge assembly. The interior trim panel has a third interior surface, a first exterior surface, a plurality of arcuate surfaces and a plurality of holes. The interior trim panel is fixed to the first interior surface of the door. The first exterior surface and the third interior surface are connected by the plurality of arcuate surfaces. Each of the plurality of holes includes at least one each of the plurality of arcuate surfaces. The resonant cavity is disposed between the door and the interior trim panel. The resonant cavity includes the second interior surface and the plurality of side surfaces of the door and the first exterior surface of the interior trim panel. The resonant cavity of the door assembly communicates with a cabin of the vehicle through the plurality of holes of the interior trim panel.

In one example of the present disclosure, the resonant cavity has a volume between 0.015 m³ to 0.040 m³.

In another example of the present disclosure, the plurality of holes have a diameter between 0.75 mm and 1.25 mm.

In yet another example of the present disclosure, the door assembly includes a ratio of a total area of the plurality of holes and a total area of the third interior surface of the interior trim panel equal to between 0.13% and 0.19%.

In yet another example of the present disclosure, the plurality of holes of the interior trim panel includes between 600 and 1200 holes.

In yet another example of the present disclosure, the door is a vertically opening tailgate.

In yet another example of the present disclosure, the door assembly further includes a sound absorber disposed in the resonance cavity.

Another door assembly for a vehicle is provided. The door assembly includes a door, an interior trim panel, and a resonant cavity. The door includes a first interior surface, a second interior surface, and a plurality of side surfaces. The door is fixed to the vehicle via a hinge assembly. The interior trim panel has a third interior surface, a first exterior surface, a plurality of arcuate surfaces and a plurality of holes. The interior trim panel is fixed to the first interior surface of the door. The first exterior surface and the third interior surface are connected by the plurality of arcuate surfaces. Each of the plurality of holes includes at least one each of the plurality of arcuate surfaces. The plurality of holes includes between 600 and 1200 holes. The plurality of holes have a diameter between 0.75 mm and 1.25 mm. The resonant cavity is disposed between the door and the interior trim panel. The resonant cavity includes the second interior surface and the plurality of side surfaces of the door and the first exterior surface of the interior trim panel. The resonant cavity of the door assembly communicates with a cabin of the vehicle through the plurality of holes of the interior trim panel. The resonant cavity has a volume between 0.015 m³ to 0.040 m³.

In one example of the present disclosure, the door assembly includes a ratio of a total area of the plurality of holes and a total area of the third interior surface of the interior trim panel equal to between 0.13% and 0.19%.

In another example of the present disclosure, the door is a vertically opening tailgate.

In yet another example of the present disclosure, the door assembly further includes a sound absorber disposed in the resonance cavity.

The above features and advantages and other features and advantages of the present disclosure are readily apparent from the following detailed description when taken in connection with the accompanying drawings.

### BRIEF DESCRIPTION OF THE DRAWING

The drawings described herein are for illustration purposes only and are not intended to limit the scope of the present disclosure in any way.

FIG. 1 is a perspective view of a partial door of a vehicle according to the principles of the present disclosure;

FIG. 2 is a perspective view of a tailgate door of a vehicle according to the principles of the present disclosure;

FIG. 3 is a perspective view of the interior of a tailgate door of a vehicle according to the principles of the present disclosure;

FIG. 4 is a partial view of a trim panel of a door for a vehicle according to the principles of the present disclosure;

FIG. 5 is a perspective view of an interior trim panel of a door for a vehicle according to the principles of the present disclosure;

FIG. 6 is a graph showing data for sound absorption of an interior trim panel for a door according to the principles of the present disclosure;

FIG. 7 is a graph showing performance data for sound pressure levels in a vehicle according to the principles of the present disclosure, and

FIG. 8 is a graph showing performance data for sound pressure levels in a vehicle according to the principles of the present disclosure.

### DESCRIPTION

The following description is merely exemplary in nature and is not intended to limit the present disclosure, application, or uses.

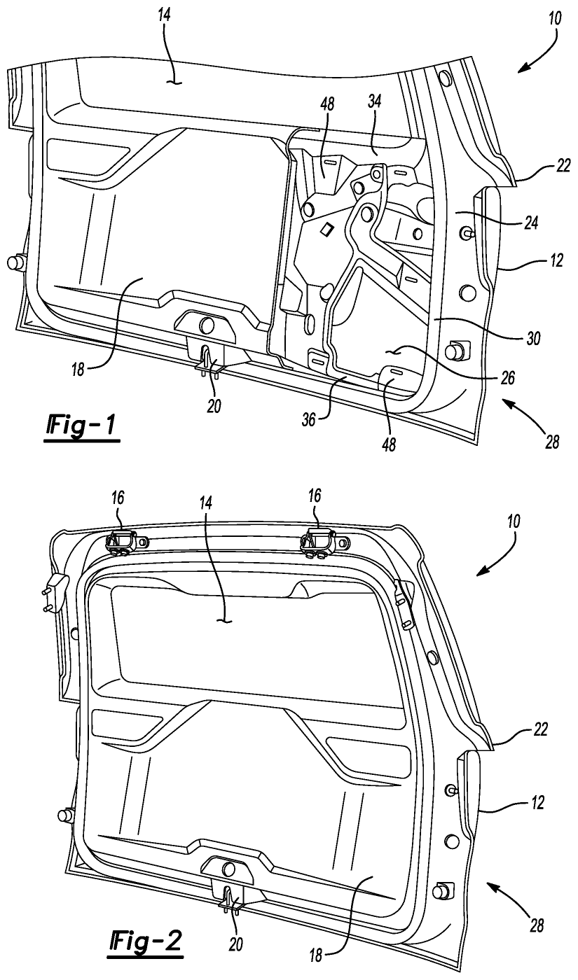

Examples of the present disclosure advantageously provide a door assembly 10 for a vehicle. Referring to FIGS. 1 and 2, a door assembly 10 is illustrated and will now be described. The door assembly 10 includes a door 12, a window 14, a pair of hinges 16, an interior trim panel 18 and a latch 20. More specifically, the door 12 of the door assembly includes an outer door panel 22 and an inner door frame structure 24. The outer door panel 22 forms a portion of the outer body of the vehicle (not shown) and includes an inner surface 26 and an outer surface 28. The inner door frame structure 24 includes a number of structural members (more clearly shown in FIG. 3) that are either formed together or otherwise connected together. The structural members include a first and second side structural members 30, 32, and an upper and lower structural members 34, 36. Each of the structural members 30, 32, 34, 36 include an inner surface 38, 40, 42, 44. Turning to FIG. 3, it is shown how the inner surfaces 38, 40, 42, 44 of the structural members 30, 32, 34, 36 combine with the inner surface 26 of the outer door panel 22 to form a cavity 46. When fully assembled, the interior trim panel 18 is disposed covering the cavity 46 and fixed to the door 12 by fastening to a plurality of raised mounting surfaces 48 of the outer door panel 22 and the inner door frame structure 24. The cavity 46 has dimensions as shown in FIG. 3. The width w of the cavity 46 is largely dependent upon the width of the door assembly 10. The height h of the cavity 46 extends from the inner surface 44 of the lower structural member 36 to the inner surface 42 of the upper structural member 34. The depth of the cavity 46 is measured from the interior trim panel 18 to the inner surface 26 of the outer door panel 22. The resulting volume v of the cavity 46 is the product of the width w, height h, and depth d.

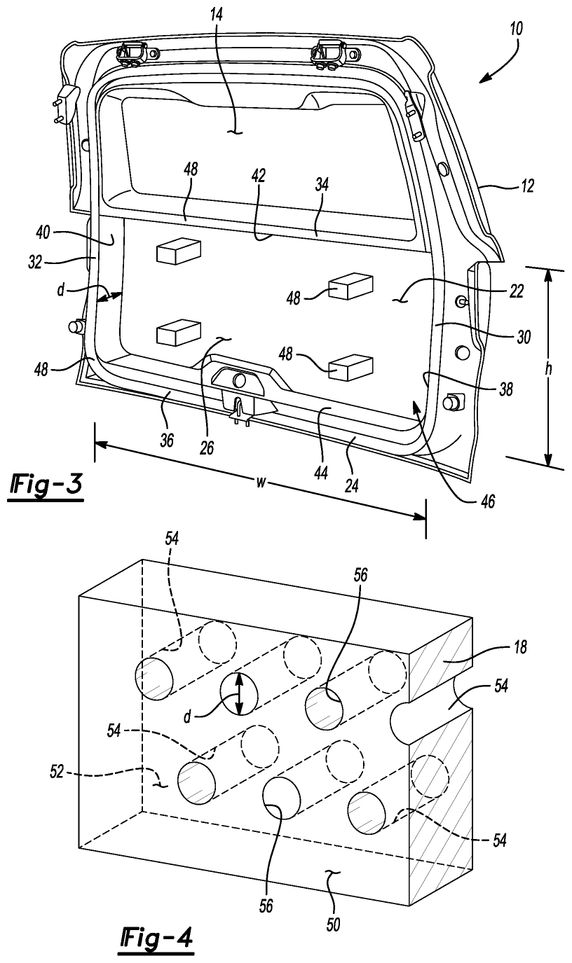

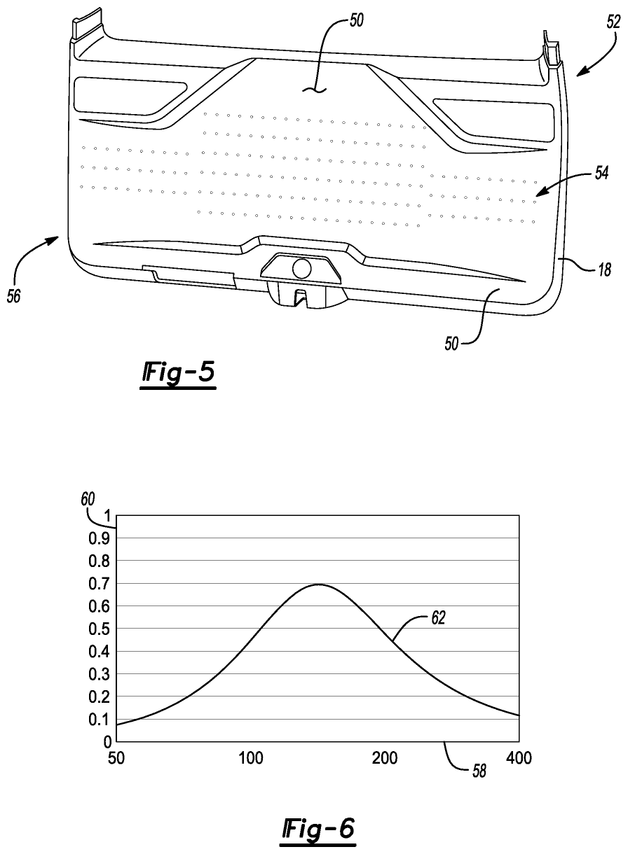

With continuing reference to FIGS. 1-3, looking now at FIGS. 4 and 5 the interior trim panel 18 of the door assembly 10 is illustrated and will now be described. The interior trim panel 18 includes a first or interior surface 50, a second or exterior surface 52, and a plurality of arcuate surfaces 54. The plurality of arcuate surfaces 54 each connect the first surface 50 to the second surface 52 thus forming a plurality of holes 56 through the thickness of the interior trim panel 18. When assembled to the door 12, the holes 56 of the interior trim panel 18 facilitate communication between the interior cabin of the vehicle and the cavity 46 of the door assembly 10.

The number of holes 56 of the interior trim panel 18, the diameter D of the holes 56, and the pattern of the holes 56 in the interior trim panel 18 may be tailored to optimize the sound performance of the vehicle. The diameter D of the holes can vary between 0.75 mm and 1.25 mm depending upon which frequencies of the vehicle are inherently loud. Additionally, the hole diameter D is small enough to not cause visual or aesthetic objection from the occupants of the vehicle. In some examples, the holes 56 can vary in size from one hole 56 to the next to achieve sound pressure level reductions at multiple frequencies.

The volume v of the cavity 46 may also be tuned to coordinate with the holes 56 of the interior trim panel 18 to achieve the best sound performance. For example, the ratio of the total hole area to the total panel area can range between 0.13% and 0.19% depending on which frequencies are being targeted for sound pressure level reduction. Other benefits include optimizing the sound pressure level at different seating locations in the vehicle. Turning to FIGS. 6-8, graphs represent the performance improvement of an example of the door assembly 10 from the present disclosure. The graph shown in FIG. 6 includes the frequencies (Hz) 58 that the interior trim panel 18 of the door assembly 10 shown in FIG. 5 is capable of absorbing sound energy shown as an absorption coefficient 60. The interior trim panel 18 performance 62 results in reduction in sound pressure levels with the highest reduction centered around 150 Hz.

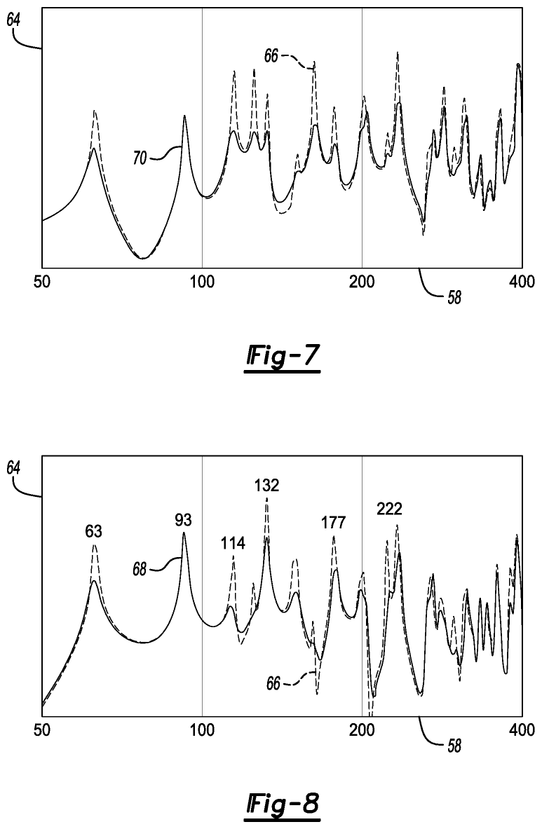

FIGS. 7 and 8 detail the improvement in sound pressure levels in different locations of the interior cabin of the vehicle. FIG. 7 illustrates the interior response in the rear seat of the vehicle while FIG. 8 provides the data for the front seat of the vehicle. For each graph, the x-axis provides the frequency 58 at which the sound pressure levels 64 are measured. The initial or baseline data 66 is provided along with the front and rear seat data 68, 70 of the sound pressure performance using the interior trim panel 18. As it can be seen, several of the peaks having high sound pressure levels are greatly reduced when simulated using models the vehicle with the interior trim panel 18. Between 100 Hz and 200 Hz, approximately a 10 dB reduction is realized in the front seat while a greater than 10 dB reduction is achieved in the back seat.

While examples have been described in detail, those familiar with the art to which this disclosure relates will recognize various alternative designs and examples for practicing the disclosed structure within the scope of the appended claims.

The following is claimed:

1. A door assembly for a vehicle, the door assembly comprising:
a door including a first interior surface, a second interior surface, a plurality of side surfaces, and wherein the door is fixed to the vehicle via a hinge assembly;
an interior trim panel including a third interior surface, a first exterior surface, and a plurality of arcuate surfaces, and wherein the interior trim panel is fixed to the first interior surface of the door and the first exterior surface and the third interior surface are connected by the plurality of arcuate surfaces; and
a resonant cavity disposed between the door and the interior trim panel, the resonant cavity including the second interior surface and the plurality of side surfaces of the door and the first exterior surface of the interior trim panel.

2. The door assembly of claim 1 wherein the interior trim panel further includes a plurality of holes each including one each of the plurality of arcuate surfaces.

3. The door assembly of claim 2 wherein the resonant cavity of the door assembly communicates with a cabin of the vehicle through the plurality of holes of the interior trim panel.

4. The door assembly of claim 3 wherein the resonant cavity has a volume between 0.015 m³ to 0.040 m³.

5. The door assembly of claim 4 wherein the plurality of holes have a diameter between 0.75 mm and 1.25 mm.

6. The door assembly of claim 5 wherein the door assembly includes a ratio of a first total area of the plurality of holes and a second total area of the third interior surface of the interior trim panel equal to between 0.13% and 0.19%.

7. The door assembly of claim 6 wherein the plurality of holes of the interior trim panel includes between 600 and 1200 holes.

8. The door assembly of claim 7 wherein the door is a vertically opening tailgate.

9. The door assembly of claim 8 further including a sound absorber disposed in the resonance cavity.

10. A door assembly for a vehicle, the door assembly comprising:
a door including a first interior surface, a second interior surface, a plurality of side surfaces, and wherein the door is fixed to the vehicle via a hinge assembly;
an interior trim panel having a third interior surface, a first exterior surface, a plurality of arcuate surfaces and a plurality of holes, and wherein the interior trim panel is fixed to the first interior surface of the door, the first exterior surface and the third interior surface are connected by the plurality of arcuate surfaces, and each of the plurality of holes includes at least one each of the plurality of arcuate surfaces; and
a resonant cavity disposed between the door and the interior trim panel, the resonant cavity including the second interior surface and the plurality of side surfaces of the door and the first exterior surface of the interior trim panel; and
wherein the resonant cavity of the door assembly communicates with a cabin of the vehicle through the plurality of holes of the interior trim panel.

11. The door assembly of claim 10 wherein the resonant cavity has a volume between 0.015 m³ to 0.040 m³.

12. The door assembly of claim 11 wherein the plurality of holes have a diameter between 0.75 mm and 1.25 mm.

13. The door assembly of claim 12 wherein the door assembly includes a ratio of a first total area of the plurality of holes and a second total area of the third interior surface of the interior trim panel equal to between 0.13% and 0.19%.

14. The door assembly of claim 13 wherein the plurality of holes of the interior trim panel includes between 600 and 1200 holes.

15. The door assembly of claim 14 wherein the door is a vertically opening tailgate.

16. The door assembly of claim 15 further including a sound absorber disposed in the resonance cavity.

17. A door assembly for a vehicle, the door assembly comprising:
a door including a first interior surface, a second interior surface, a plurality of side surfaces, and wherein the door is fixed to the vehicle via a hinge assembly;
an interior trim panel having a third interior surface, a first exterior surface, a plurality of arcuate surfaces and a plurality of holes, and wherein the interior trim panel is fixed to the first interior surface of the door, the first exterior surface and the third interior surface are connected by the plurality of arcuate surfaces, each of the plurality of holes includes at least one each of the plurality of arcuate surfaces, the plurality of holes includes between 600 and 1200 holes, and the plurality of holes have a diameter between 0.75 mm and 1.25 mm; and
a resonant cavity disposed between the door and the interior trim panel, the resonant cavity including the second interior surface and the plurality of side surfaces of the door and the first exterior surface of the interior trim panel and the resonant cavity has a volume between 0.015 m³ to 0.040 m³; and
wherein the resonant cavity of the door assembly communicates with a cabin of the vehicle through the plurality of holes of the interior trim panel.

18. The door assembly of claim 17 wherein the door assembly includes a ratio of a first total area of the plurality of holes and a second total area of the third interior surface of the interior trim panel equal to between 0.13% and 0.19%.

19. The door assembly of claim 18 wherein the door is a vertically opening tailgate.

20. The door assembly of claim 19 further including a sound absorber disposed in the resonance cavity.
